(19) United States
(12) Patent Application Publication
(10) Pub. No.: US 2024/0009491 A1
(43) Pub. Date: Jan. 11, 2024

(54) EFFECTIVE CONTROL AND MANAGEMENT OF FOREST FIRES

(71) Applicant: Jairus Chegero Godeka, Woodburn, OR (US)

(72) Inventor: Jairus Chegero Godeka, Woodburn, OR (US)

(21) Appl. No.: 18/169,034

(22) Filed: Feb. 14, 2023

(51) Int. Cl. A62C 3/02

(52) U.S. Cl. CPC A62C 3/0285

(57) ABSTRACT

Based on the losses incurred after devastating forest fires both in human and material costs, I have come up with methods to substantially minimize these losses. The 2018 Paradise fire in California led to the loss of 58 human lives including property and extensive damage to the environment. My new methods include measures I have put in place with new applications. There is no magic way to effectively control and manage wild forest fires, however, the methods I intend to put into use may substantially if properly applied lead us into a new era of forest fire management and control.

### A BRIEF DESCRIPTION OF MY IDEAS

1) Picture in your mind a vast forest stretching over 20 miles in length and 2 miles in width. When fires break, there is no barrier or method to effectively control the fire. This type of fire is known as Crown fire. It engulfs the tops of trees, and the effects are worse when assisted by high winds. The other type of fire is the Surface fire which burns on the land surface. Unlike Crown fires, Surface fires are easily accessible and much easier to manage and put out. How then do we, using our example effectively control and manage a Crown fire outbreak on our 20-mile X 2-mile stretch?

2) Imagine the length of our forest (20 miles) broken into four sections. Each section will be five miles long. In between each section (every 5 miles) we will have a complete clearing of shrubs, trees, and vegetation. The clearing will be 100 yards wide and running the complete width of the forest (2 miles). The goal is to (in the event of fire) bring the fire to a stop by denying it fuel. Crown fires as I mentioned earlier are not easy to control and this gets more complicated when coupled with strong winds, case in point, the 2018 Paradise fire in California that consumed vast amounts of trees, property, including a devastating loss of more than 50 innocent human lives.

3) My intention in having a clearing of 100 yards X 2-miles is to give the fire a pause, if not a complete stop. Firemen will be stationed at these cleared sections instead of chasing the fires and putting their lives in danger. Because the initial costs to implement these ideas might seem to be high, we may need to consider the long-term benefits. The US government spent Approximately 3 billion dollars in 2022 managing and controlling forest fires. The goal is to contain the fires to a specific section during fire outbreaks. There is a very good likelihood of the fires jumping the cleared sections and into the next patch. This may happen when the fire is driven by strong winds, which may result in fire ambers flying in the air past the cleared patch and into the next parch of the forest. My solution given this situation is to construct high-rise towers like electric grid towers (pylons) that traverse forested areas. They will be linked by cable and expanding water hoses which will be strung like electrical wires with attached water sprinklers that will spray water in an upward and circular direction. In the event of a fire, the sprinklers will be used to contain the flying and flaming ambers and hopefully put the burning ambers out before they spread fire. Unfortunately, water sources are or may not be readily available everywhere. We may need to do a cost benefit analysis before piping-in water from long distances.

4) Alternatively, we could clear pathways of 100-yards every ten miles instead of five miles where necessary depending on the region of the country, part of the state, terrain, wind speed, and spacing between trees.

### DRAWING SPECIFICATIONS

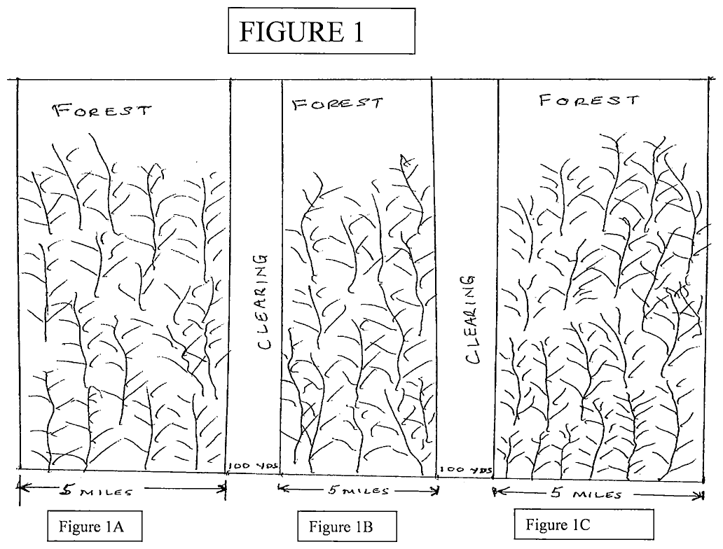

### Drawing FIG. 1

### Brief Description

FIG. 1)—The drawing depicts a forest sectioned into three partitions with two cleared paths.

### Legend for Drawing FIG. 1

FIG. 1A) Five-mile-long forest stretch.

FIG. 1B) Five-mile-long forest stretch.

FIG. 1C) Five-mile-long forest stretch

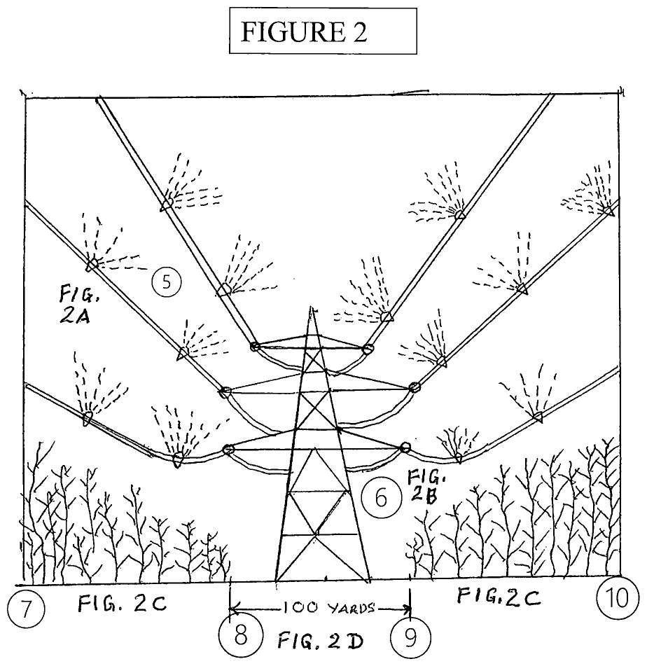

### Drawing FIG. 2

### Brief Description

FIG. 2)—Pylon(s) networked with water sprinklers on water conduit cables.

### Legend for Drawing FIG. 2

FIG. 2A) Is represented by #5 (on drawing FIG. 2) Sprinkler system.

FIG. 2B) Is represented by #6 (on drawing FIG. 2) pylon with attached water conduits.

FIG. 2C) Is represented by #s 7-8, and 9-10 (on drawing FIG. 2) Show forested areas

FIG. 2D) Is represented by #s 8-9 (on drawing FIG. 2) Shows 100-yard-wide clearing.

1) These methods properly employed as described will minimize the losses associated with out-of-control forest fires.

2) Firemen will work more effectively and minimize loss of lives and property.

3) The financial costs associated with putting out forest fires will be minimal compared to current costs.

4) There will be more trees to harvest after forest fires, benefiting the environment and investors.

5) New plantations (after harvest) will be planted with all these new factors in consideration allowing for 100 yards spacing every 5 miles of newly planted trees.

6) The cost of maintenance will be lower because the focus will be for the most part geared towards clearing the 100-yard-wide pathways of shrubs, trees, and vegetation before and during the fire season.

7) We will target specific areas of the forest instead of the whole forest, saving money and minimizing the loss of lives.

8) The cost of recovery for civilians after a forest fire is astounding and expensive for most especially those without insurance coverage. Clearing 100-yard pathways around concentrated communities in forested areas might be the first line of defense.

9) Controlled burning by Firemen may be the most effective way to clear the 100-yard-wide pathways of shrubs and vegetation thereby reducing associated costs and fire spread.

10) Aesthetically, those of us who like to see continuity in forested areas while driving, biking, or walking may have to sacrifice that luxury. It may come down to a choice of giving up one option to benefit from the other.
